(19) United States
(12) Patent Application Publication
(10) Pub. No.: US 2008/0075253 A1
(43) Pub. Date: Mar. 27, 2008

(54) Method and apparatus for displaying time and date of a calling party

(75) Inventor: Savita S. Muttagi, Magarpatta City (IN)

Correspondence Address: COHEN, PONTANI, LIEBERMAN & PAVANE, 551 FIFTH AVENUE, SUITE 1210, NEW YORK, NY, 10176, US

(73) Assignee: Avaya Technology LLC

(21) Appl. No.: 11/516,331

(22) Filed: Sep. 6, 2006

(51) Int. Cl. H04M 3/42

(52) U.S. Cl. 379/201.01

(57) ABSTRACT

A method for displaying time and date of a calling party includes receiving an incoming call at called party equipment and determining a time and date of the calling party using information received with the incoming call. The determined time and date of the calling party are then displayed on the called party phone.

### BACKGROUND OF THE INVENTION

1. Field of the Invention

The present invention relates to a method and apparatus for displaying on a called party's phone screen an indication of the time and date of a calling party.

2. Description of the Related Art

Communication networks have allowed companies and individuals to conduct business globally. Even with the availability of email and messaging, a large portion of communications are still conducted by telephone. For this purpose, many companies have call centers which receive calls from customers in all parts of the world, e.g., for providing customer assistance and taking sales orders. Furthermore, many companies have separate offices located in different parts of the world which communicate with each other for project related discussions and meetings.

Time is an important resource. Call centers which take calls from all over the world typically have a large display of clocks showing the time in various parts of the world. However, it is sometimes difficult to determine where the calling party is located. Thus, to increase efficiency of telephonic discussions it would be beneficial for a called party to know the time and date of a calling party without having to specifically inquire the calling party for the information or to determine the information from a multiple clock display.

### SUMMARY OF THE INVENTION

According to an embodiment of the present invention, a method for displaying a time and date of a calling party on the user interface of a called party's phone is provided. According to the method of the present invention, a calling party places a call to a called party. Equipment at the called party end determines a time and date of the calling party using information received with the incoming call. The time and date of the calling party are then displayed on the called party phone.

The step of determining the time and date may include determining a country code from a calling party number of the incoming call and looking up the country code in a database, which may be stored at the called party or external to the called party equipment. The country code may, for example, be determined from the Calling Line Identification (CLID) of the incoming call.

The time and date of the calling party may alternatively be obtained from information directly indicating the time and date of the calling party that is sent with the incoming call.

The display of the time and date feature is selectively enabled by the called party and the time and date of the calling party are displayed on the called party's user interface only if it is determined that the time and date display feature is enabled by the called party.

The invention is also directed to an apparatus having a processor and a memory storing a computer program including executable instructions for performing the above method steps.

The present invention provides a benefit to operators at call centers who answer calls from customers across the globe by allowing the operator to address the caller appropriately. For example, the operator can greet the caller with “good morning”, “good afternoon”, or “good evening”. Since there can be a prejudicial attitude against remote call centers (i.e., some customers prefer speaking with someone closer to home), such a greeting can improve client relations by giving the impression that the call center is not so remote.

A further benefit is that the present invention allows operators at call centers to appropriately respond to caller's requests based on the time of the calling party. For example, if it is determined that a caller is calling late at night and the caller's request requires performance of a certain task which takes some time to complete, the operator can schedule that task to be done before the caller arrives at work the next morning. However, if the caller is calling in the morning, the operator can schedule the task to be performed so as to cause the caller the least amount of inconvenience.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIGS. 1a and 1b are schematic block diagrams each showing a system in which the present invention is implemented;

FIG. 2 is a flow diagram of a method of displaying time and date of a calling party according to an embodiment of the present invention; and

FIG. 3 is a timing diagram for the steps of the method of FIG. 1.

### DETAILED DESCRIPTION OF THE PRESENTLY PREFERRED EMBODIMENTS

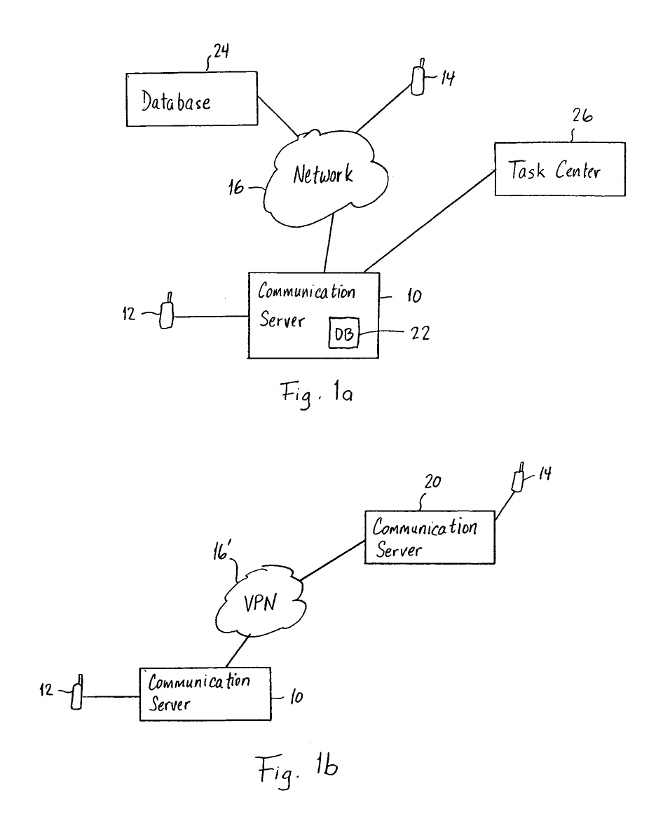

FIG. 1a is a schematic block diagram showing a system in which the present invention is implemented. A phone 14 of party A is connected to a network 16. A communication server 10 is connected to a phone 12 of party B and to the network 16. The communication server 10 may be part of a private branch exchange (PBX) and comprise a processor running software to provide communication functions for telephone 12. For example, the communication server may comprise an Avaya S8300 Media Server controlling an Avaya G350 Media Gateway and running Avaya Communication Manager software. The network may comprise the Public Switched Telephone Network (PSTN), an Internet Protocol (IP) network, or a combination thereof. The phones 12, 14 may comprise IP phones or any other type of phones which may be used to communicate via the PSTN or IP network. The telephone 12 may comprise one of a plurality of telephones that are connected to a call center or Business Process Outsourcing (BPO) center.

A task center 26 is connected to the communication server 10. The task center may comprise a task tracking or task performing server of the owner of the communication server 10. The operator of telephone 12 can enter data which is sent to the task center as described below.

FIG. 1b shows a further embodiment similar to FIG. 1b except that the phone 14 is connected to the network 16 by another communication server 20.

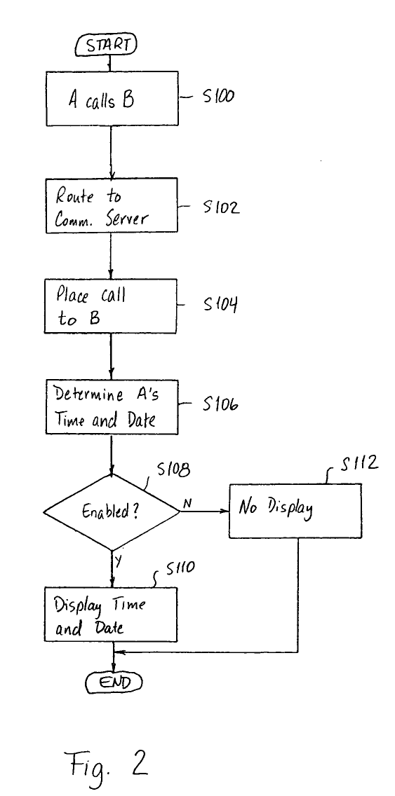

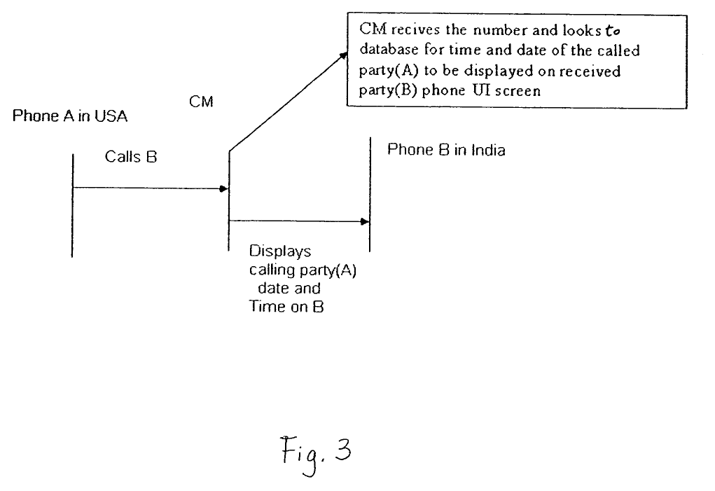

According to FIGS. 2 and 3, party A, the calling party, places a call to party B, the called party, step S100. The call is routed to the communication server 10 to which party B is registered, step S102. The communication server 10 places the call to telephone 12 of the called party, step S104. The communication server 10 also determines the time and date of the calling party, step S106. The communication server then determines whether the called party enabled the feature of displaying the time and date of the calling party, step 108, displays the time and date of the calling party on a user interface of the called party's phone if the feature is determined to be enabled, step S110, and does not display the time and date if the feature is determined not to be enabled, step S112.

The step of determining the time and date of the calling party, step S106 may be effected by determining the country code of the calling party from the calling party number of the phone call. When a phone call is placed, the telephone network sends a calling party number in a data packet with the phone call. The calling party number may be referred to as the Calling Line Identification (CLID). The communication server interrogates this information to determine the country code of the calling party. The country code is then looked up in a database 22. The database contains either the time difference between that country code and the current local time of the communication server or the actual time (in the latter case, the database is updated periodically, i.e., every minute or every five minutes). The database 22 may be arranged at the communication server 10 as shown in FIG. 1a. A further or alternative database 24 may be connected to a data network 16 such that the communication server 10 contacts the database 24 through the data network 16.

For countries which span more than one time zone, e.g., the United States of America, the country code may not be enough to determine the time of the calling party. In that case, the communication server interrogates the calling party number for a regional or area code. The time and date may then be determined looking up the country code and the area code in the database.

The embodiment of FIG. 1a may be applied to call centers in which incoming calls are received from individuals who do not have communication servers. According to another embodiment using the system configuration of FIG. 1b, both the calling party and the called party have communication servers 10, 20. In this case, the communication server 20 of the calling party may include data directly indicating the time and date of the calling party to be sent with the phone call to the communication server 10 of the called party. In this case, the step of determining the time and date of the calling party includes interrogating this data included in the call. This particular embodiment is applicable to cases where two separate offices of a company are communicating via telephone. Each of the communications servers 10, 20 may be part of a virtual private network 16′ and programmed to send and receive specific data indicating the time and date of the calling party. Thus the called party equipment obtains the time and date of the calling party directly from the information sent with the call.

Furthermore, although the communication server 10 is depicted as being separate from the phone 12, it may be possible for the functions of the communication server 10 for determining and displaying the time and date of the calling party to be incorporated directly into the phone 12, thereby obviating the need for a separate communication server.

Call centers having operators operating telephones 12 and who receive calls from customers may enable the operators to perform or schedule service tasks for customers based on the request received from a customer. In this case, knowing the time and date of the calling party can aid the operator in determining the appropriate schedule for a task that is required to be performed for the customer.

Thus, although the fundamental novel features of the invention as applied to a preferred embodiment thereof have been shown and described, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for displaying to a called party the time and date of a calling party, comprising the steps of:
receiving, from a communication network, an incoming call for a called party at called party communication equipment;
determining, by the communication equipment, a time and date of the calling party using information received with the incoming call;
displaying, by the communication equipment, the time and date of the calling party on the called party phone.

2. The method of claim 1, wherein said step of determining comprises determining a country code from a calling party number of the incoming call.

3. The method of claim 2, wherein said step of determining the time and date comprises using a database associating the country code with a time and date.

4. The method of claim 3, wherein the database is stored by the communication server.

5. The method of claim 3, wherein the database is stored externally to the communication server.

6. The method of claim 5, wherein the communication server communicates with the database using a communication network.

7. The method of claim 3, wherein said step of determining the time and date comprises using a database associating the country code with a time and date.

8. The method of claim 1, wherein the incoming call includes information directly indicating the time and date of the calling party and said step of determining comprises determining the time and date of the calling party from the information sent with the incoming call.

9. The method of claim 1, wherein said step of displaying comprises determining whether the time and date display feature is enabled by the called party and displaying the time and date of the calling party only if it is determined that the time and date display feature is enabled by the called party.

10. The method of claim 2, wherein said step of determining a country code comprises using the Calling Line Identification (CLID).

11. The method of claim 1, wherein the communication server is connected to phones of a call center or Business Process Outsourcing (BPO) center.

12. The method of claim 1, wherein the communication equipment is the called party phone.

13. The method of claim 1, wherein the communication equipment is a communication server connected between the communication network and the called party phone.

14. The method of claim 1, further comprising the step of performing or scheduling a task required by the incoming call based on the time and date of the calling party.

15. An apparatus having a processor and a memory storing a computer program including executable instructions for performing the steps of:
receiving an incoming call for a called party at said apparatus;
determining, by said apparatus, a time and date of the calling party using information received with the incoming call;
displaying, by said apparatus, the time and date of the calling party on the called party phone.
